(19) United States
(12) Patent Application Publication
(10) Pub. No.: US 2018/0349819 A1
(43) Pub. Date: Dec. 6, 2018

(54) VALUE ASSESSMENT AND ALIGNMENT DEVICE, METHOD AND SYSTEM

(71) Applicant: LUCELL PTY LTD, Sydney, New South Wales (AU)

(72) Inventor: Andrew COCHRANE, Sydney, New South Wales (AU)

(21) Appl. No.: 15/778,021

(22) PCT Filed: Nov. 22, 2016
(86) PCT No.: PCT/AU2016/051139

§ 371 Date: May 22, 2018

(30) Foreign Application Priority Data
Nov. 23, 2015 (AU) 2015904818

(51) Int. Cl. G06Q 10/06; G06N 5/04; G06N 5/02

(52) U.S. Cl. CPC G06Q 10/0639; G06N 5/025; G06N 5/04

(57) ABSTRACT

The present invention relates to device, system and method for alignment of values, and in particular a value relationship device, system and method that includes qualifying and quantifying alignment of requestor's values to a provider's values so as to align the relationship between requestor and provider on computer enabled search systems.

### TECHNICAL FIELD

The present invention relates to device, system and method for alignment of values, and in particular a value relationship device, system and method that includes qualifying and quantifying alignment of an individual's or an organisation's values to one or more individual or organisational values.

### BACKGROUND

An individual, representing themselves or an organisation, is often faced with seeking specific goods and/or services without having the means to determine whether there will be a fit between their requirements and the provider's offerings with regard to the specific goods and/or services. Possibly this is due to there being no means to visualise how an individual or organisation (collectively a provider) will meet or “fit” such required needs because the “fit” is not quantified nor qualified by any objective measure.

This lack of objective measure in the desired “fit” crosses many relationships including:
1. an individual with one or more other individuals;
2. an individual with one or more organisations;
3. an organisation with one or more individuals; and
4. an organisation with one or more other organisation.

Thus, choosing an alignment in terms of fit (be it similar—complementary—or opposite—supplementary) between individuals and/or organisations is near impossible.

A party, albeit an individual or an organisation (in its many forms), often needs to internally “value” its function in offering goods and or services, so as to locate it strengths and/or plan for improvement. Therefore, individuals or organisations require their internal valuation to be objectively held against external standards. However, in the absence of any tools to perform such tasks, such assessments are not able to be easily performed across organisations.

Here, the term “value” is used in terms of principles or standards of behaviour. Traditionally, organisations use mission statements and the like to let the public know the values adhered to; however, such statements often fall wide of the mark for many reasons. Therefore, it would also be helpful if objective valuations of fit were available to be utilised by external parties, such as by individual viewers, potential consumers and/or customers to see if the organisational offerings, in terms of values, meet with their individual needs.

A relationship management analogy that is perhaps similar to individual need being aligned to organisational supply is in the area of dating services, where individuals are aligned with other compatible individuals.

Specific web dating sites have claimed to be able to use algorithms to aid the formation of positive relationships by analysing behaviours and desires of individuals to isolate the most appropriate matches. If we extrapolate this positive relationship formation to take into account the fact that organisations can be reduced to individual expressions, then the matching of individuals to organisations and/or other individuals should be possible.

The difference between a dating site to a site that enables people seek a positive delivery of a good or service for a relationship from a provider is that these people are not seeking “harmony”, but they are seeking an outcome that will be truly satisfying. Therefore, relationship algorithms suffer the common difficulty of focusing on the allocation of overlapping values, rather than concentrating on what value combinations will generate the optimal output along with providing a fulfilling journey.

This issue of degree of overlapping values was addressed in part by Brian Uzzi and Jarrett Spiro (2005) in their work titled “Collaboration and Creativity: The Small World Problem” (AJS Volume 111 Number 2 (September 2005): 447-504).

This study found that creativity was optimised by particular Q values, which are the measure of a team's members familiarity with each other. If the Q factor is set optimally for maximum creativity, then team members will not be too familiar but also not total strangers to each other. That is, Q has an optimal range for creativity.

This study of Q Values addressed the question of whether “a social system of actors amplifies or stifles one another's creativity”? One form of social organisation is termed “the small world network” which “is a network structure that is both highly locally clustered and has a short path length, two network characteristics that are normally divergent”, so as “to be a potent organizer of behavior . . . account[ing] for how quickly ideas flow through disciplines” and lead to creative successes.

What is the connectivity that ties a small world network together leading to such creativity? It is proposed that from the assessments made the Q values may be values that are early adoption values being discussed in the small world network for acceptance as a “normative [value], when considered over a fuller time frame”.

It would be useful to provide a device for individual or organisational value assessment along with a value alignment device that enables value correlations to be viewed in terms of fit, so as to enable optimisation of one or more provider selections in terms of aligned values.

To date there is no means to associate the fit of an individual's need(s) with an organisation's delivery of goods and/or services in terms of values. Let alone determine the quality of the overall customer experience as a value assessment in terms of value fit.

It is an object of the present invention to overcome or ameliorate at least one or more of the disadvantages of the prior art, or to provide a useful alternative.

### SUMMARY OF THE INVENTION

The present invention relates to a device, method and system to enable providers of goods and services to be assessed and aligned to the values and needs (as declared, inferred and/or interpreted) of requestors (being potential beneficiaries) of the provider's goods and/or services (be they individuals, organizations or teams).

This invention takes the form of a device that collects values data from an individual or organisation, generates a values signature for each individual or organisation and compares values signatures in terms of correlation alignment and fitness from selected individuals and organisations. The values signatures have a quantification value or code to enable a relative assessment of the contributory values so as to align an individual or organisation as a requestor with one or more provider individuals or organisations. The providers are selected with the value signature alignment so that the fit with the requestor is:
1. appropriate to requestor's needs as stated; and
2. aligned, in a complementary or supplementary manner, through the correlation of the provider's values signatures to the requestor's values signatures;
so as to optimise the probability of a mutually beneficial outcome. The alignment of values signatures is to optimise the probability of a mutually beneficial relationship between the requestor and one or more providers.

Consistory Clause

According to one aspect of the invention there is provided a value assessment and alignment device for performing a method of generating value signatures, wherein the method includes a value assessment process, wherein the value assessment process is performed by programming instructions embodied in a computer readable storage medium and includes the steps of:
(a) capturing value data, wherein the value data relates to specified predefined values of an individual;
(b) processing said value data to generate a values signature;
(c) generating an organisational values signature by adding a values signature from one individual to one or more values signatures of other individuals within the same organisation to produce a values signature of an organisation;
(d) calculating alignment of values signatures by determining the correlation of component value data in respective values signatures between:
   i. two or more individuals;
   ii. two or more organisations; or
   iii. one or more individuals and one or more organisations, to identify values signatures that are aligned in a complementary or supplementary manner;
wherein each said values signature is a quantification of values from an individual, or collection of individuals forming an organisation, such that said alignment of values signatures is provided between individuals, organisations or combination of an individual and one or more organisations.

According to another aspect of the invention there is provided a system for aligning value signatures between a requestor and one or more providers of goods or services including a value assessment and alignment process, wherein the value assessment process is performed by programming instructions embodied in a computer readable storage medium, wherein the value assessment process, including:
(a) a value assessment and alignment device according to any one of claim 1 to claim 13; and
(b) a method of aligning value signatures according to any one of claim 14 to claim 26.

### DESCRIPTION

The invention provides a device, method and system that reveal one or more alignments between a requestor's values, via the correlation of values signatures, to a provider's values.

The invention further provides an Value Assessment and Alignment Device, method and system (VAAD) that assists users in visualising the fit of values leading to the presentation one or more suitable providers (such as individuals or organisations) whose values fit the requestor's (also either an individual or an organisation) need.

For a better understanding of the invention and to show how it may be performed, a preferred embodiment will now be described, by way of non-limiting example only, with reference to the accompanying drawings and examples.

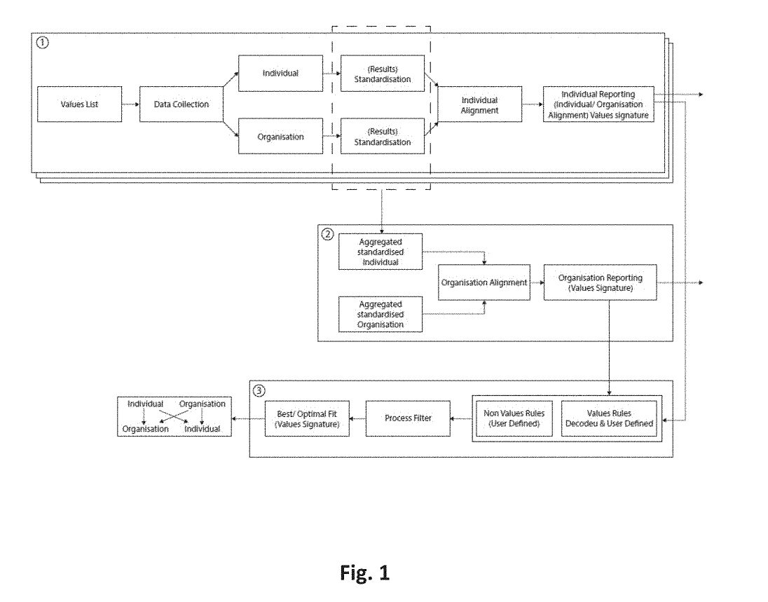

FIG. 1 is a flowchart showing a method for value capture and alignment according to an embodiment of the invention.

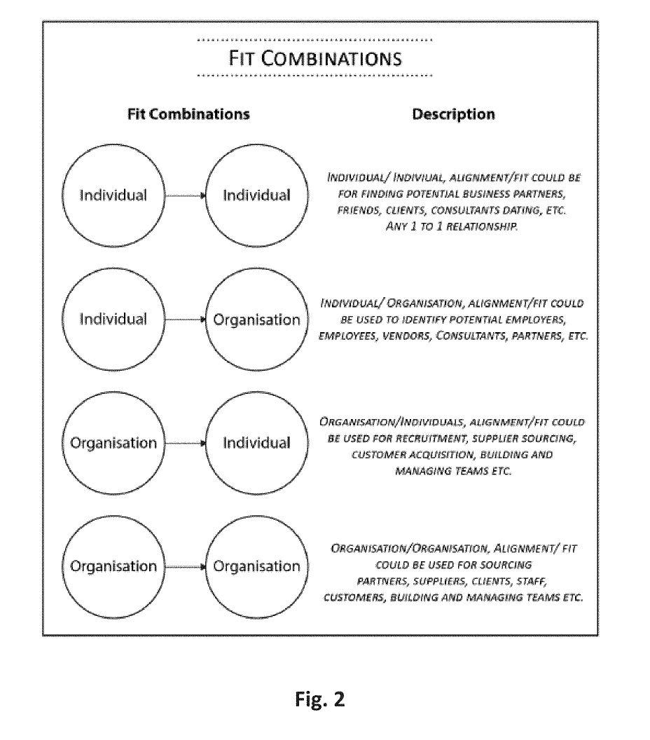

FIG. 2 shows a fit combination between requestors and providers according to an embodiment of the invention.

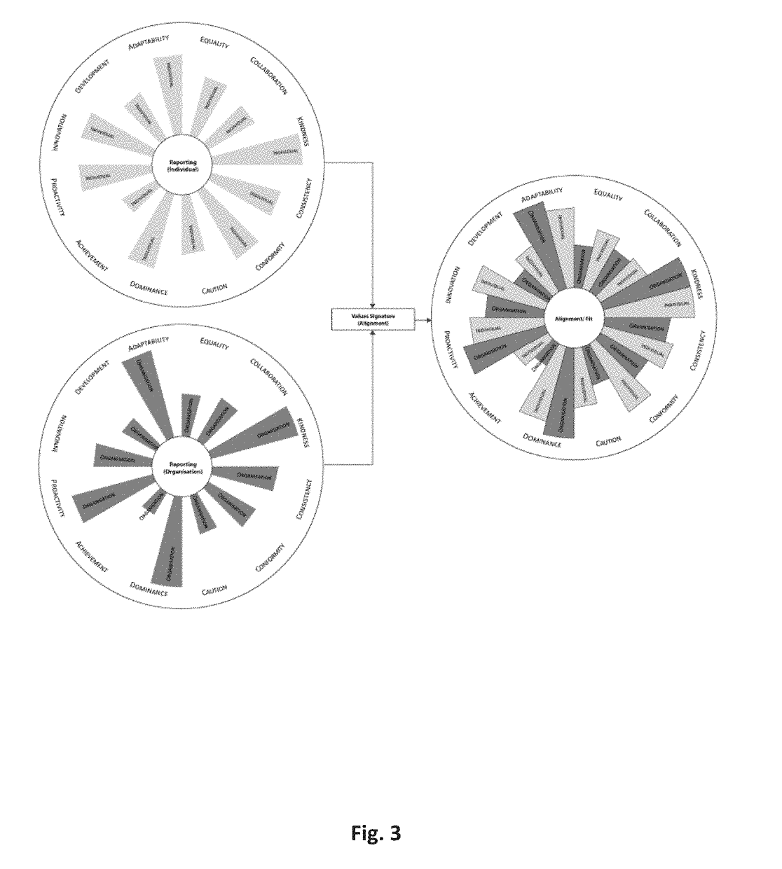

FIG. 3 shows an exemplary correlation between individual and organisational values signatures as a visual representation of a good alignment and fit according to an embodiment of the invention.

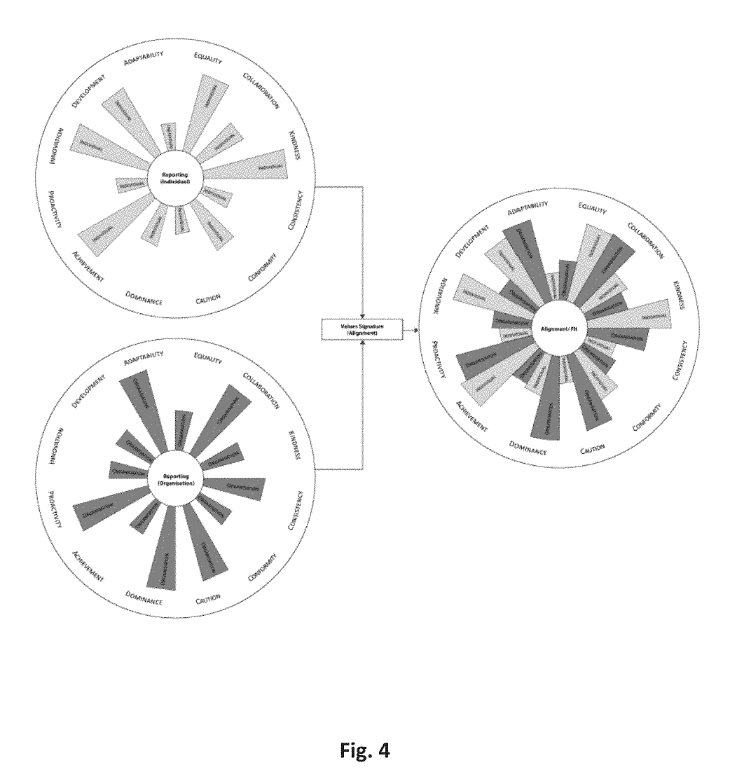

FIG. 4 shows an exemplary correlation between individual and organisational values signatures as a visual representation of a poor alignment and fit according to an embodiment of the invention.

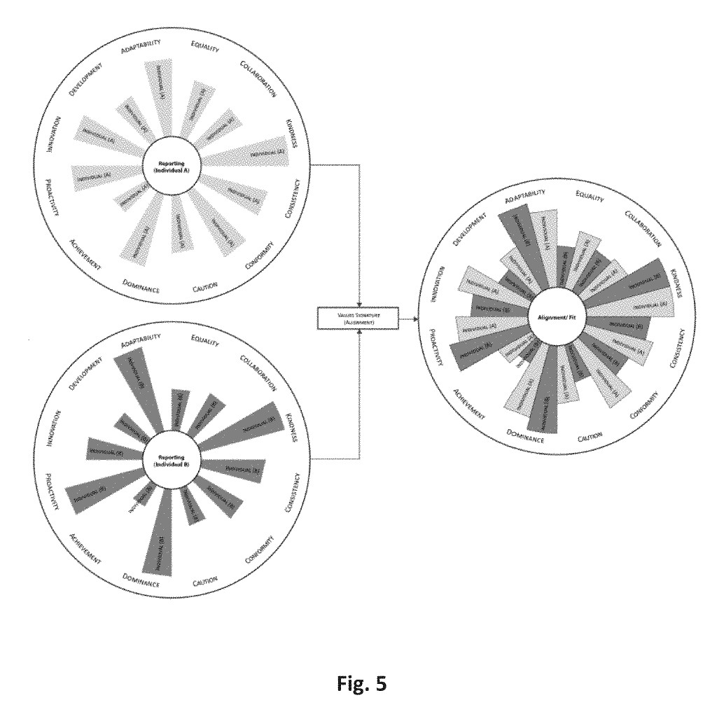

FIG. 5 shows an exemplary correlation between two individuals and their values signatures as a visual representation of a good alignment and fit according to an embodiment of the invention.

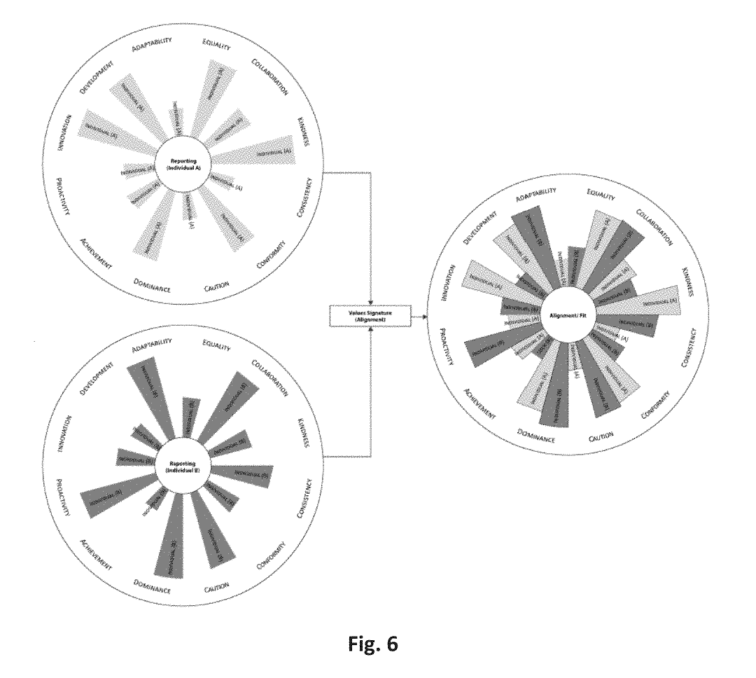

FIG. 6 shows an exemplary correlation between two individuals and their values signatures as a visual representation of a poor alignment and fit according to an embodiment of the invention.

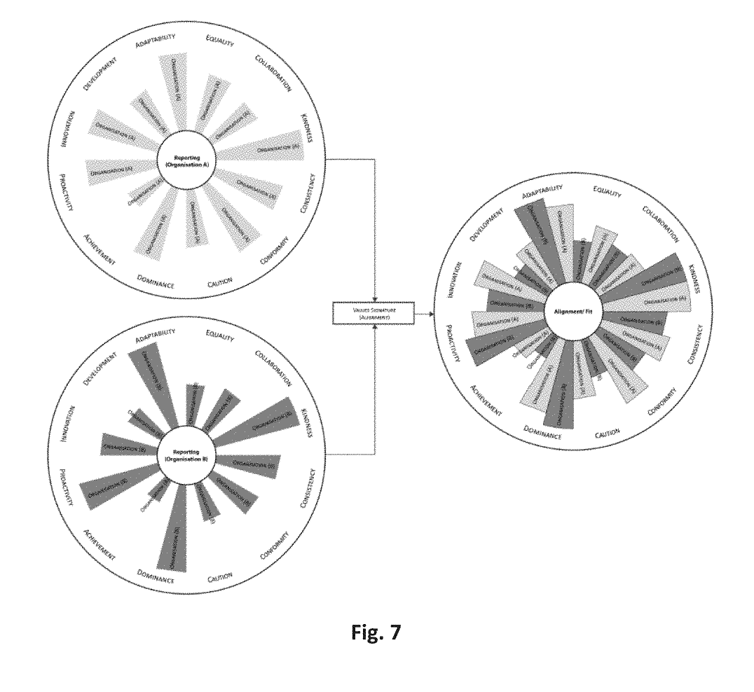

FIG. 7 shows an exemplary correlation between two organisations and their values signatures as a visual representation of a good alignment and fit according to an embodiment of the invention.

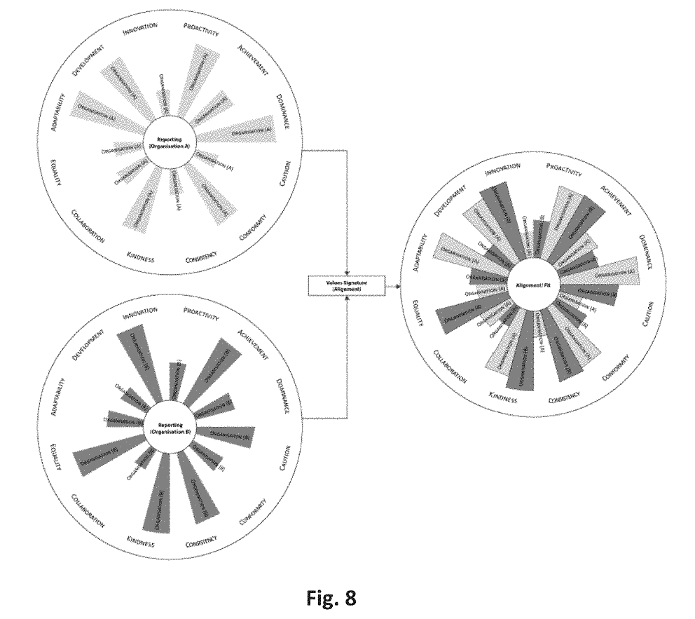

FIG. 8 shows an exemplary correlation between two organisations and their values signatures as a visual representation of a poor alignment and fit according to an embodiment of the invention.

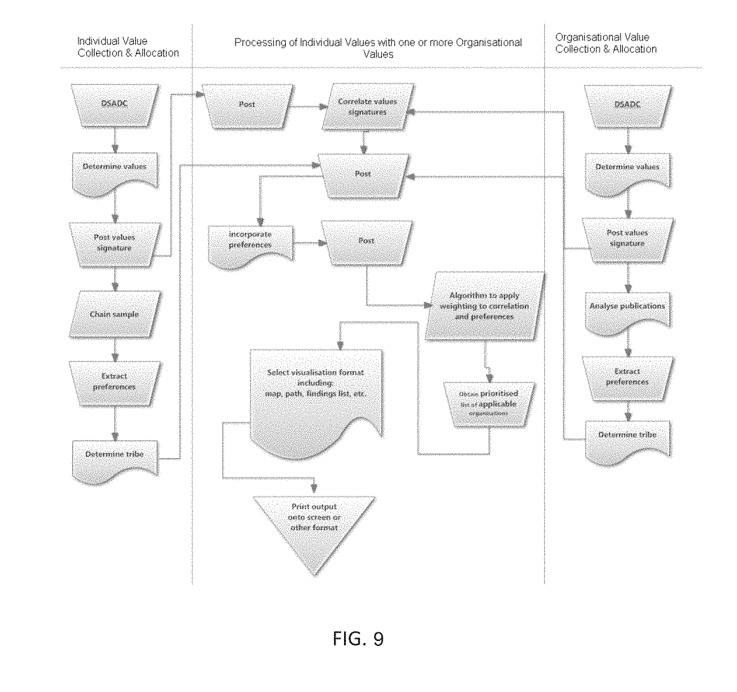

FIG. 9 is a flowchart showing a method for value capture according to an embodiment of the invention.

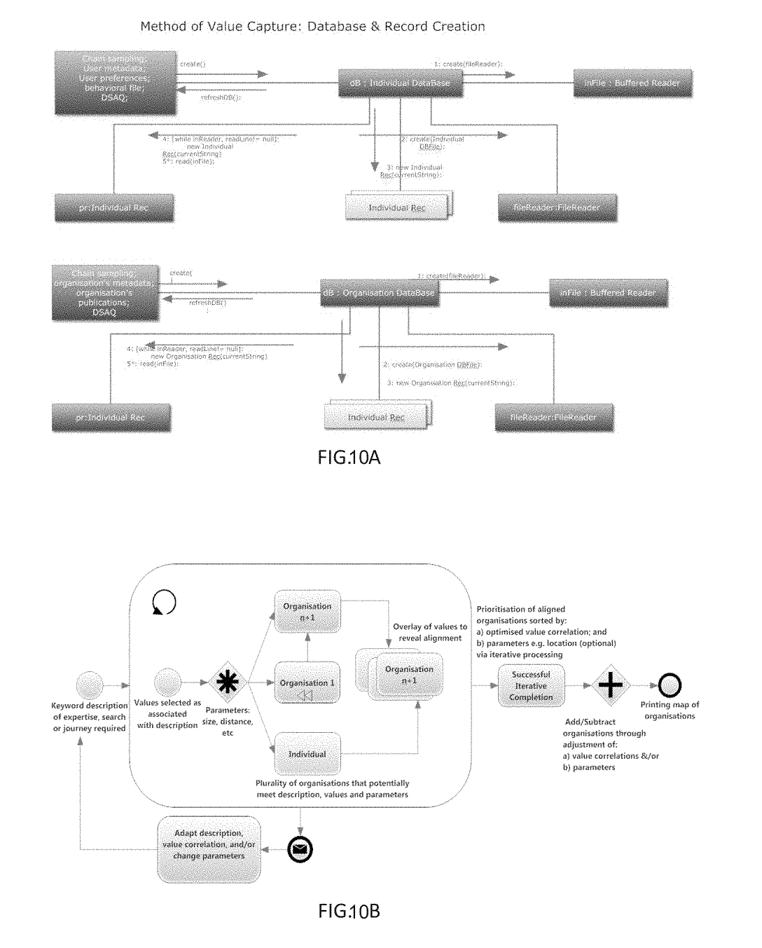

FIG. 10A is an exemplary value collection method and system for the individual and organisation according to an embodiment of the invention.

FIG. 10B is an exemplary value alignment method and system for the individual and organisation according to an embodiment of the invention.

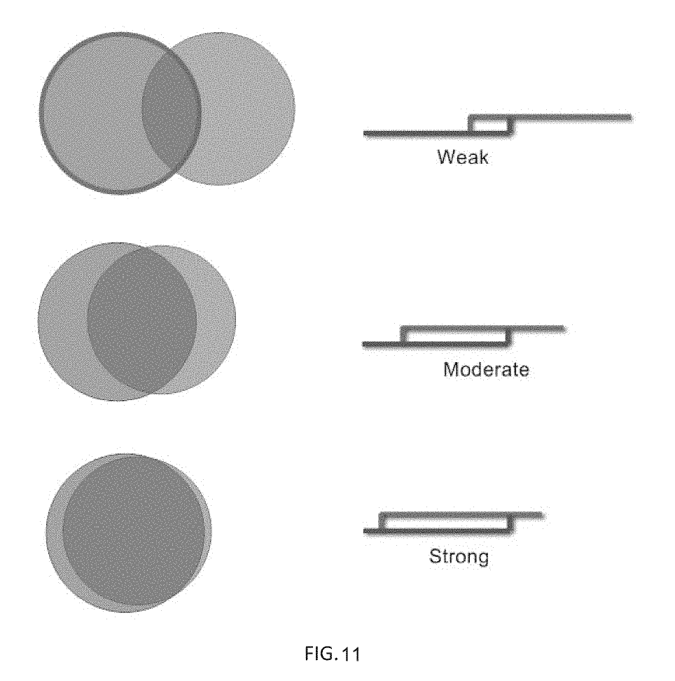

FIG. 11 is the exemplary correlation of FIG. 10B containing a visual representation of correlations between individual and organisational values according to an embodiment of the invention.

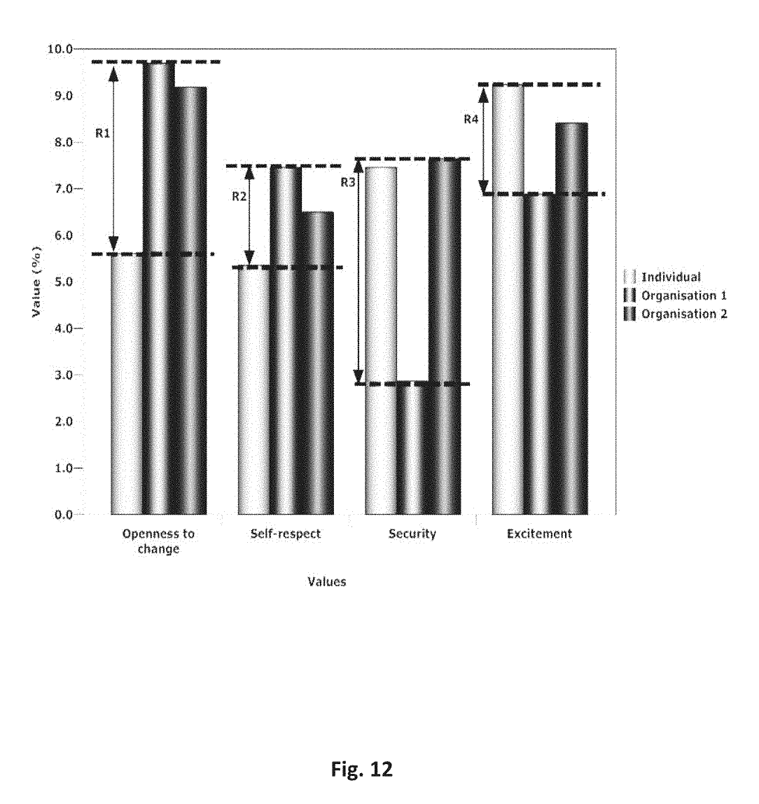

FIG. 12 shows exemplary organisations with their associated values as selected according to an embodiment of the invention.

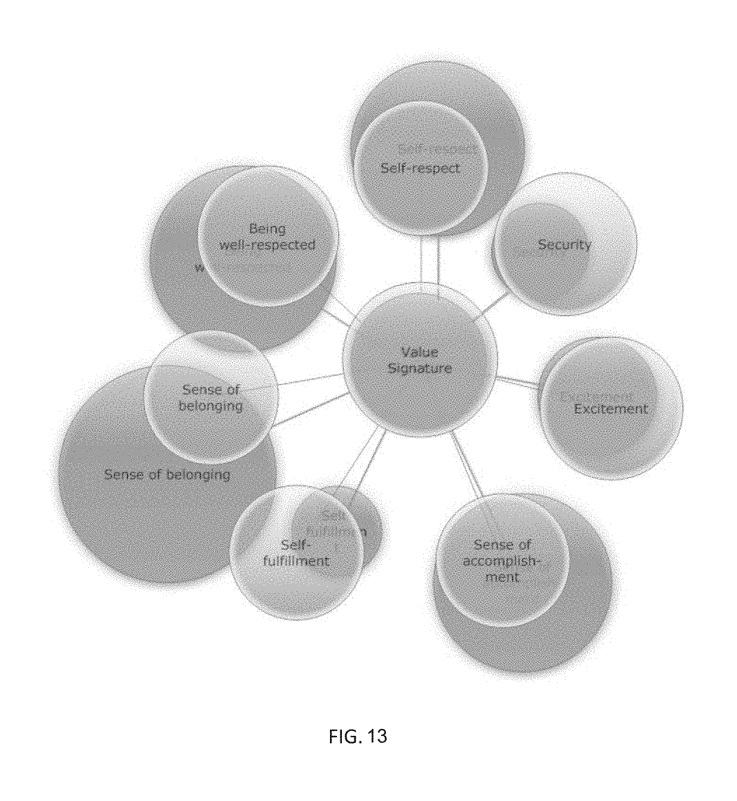

FIG. 13 shows an exemplary visual representation of value alignment between and organisation and a user to form a values signature.

### DICTIONARY OF DEFINED TERMS

Table 1 is a dictionary of terms defined according to the invention.

The relationships described within the patent typically use an individual viewing, and/or participating as a requestor in an exchange with one or more providers, which often takes the form of an organisation (however, an individual may also be considered a provider). Here, the individual and the organisation are actors that are used for explanatory purposes. These actors can be involved in exchanges for which any party (an organisation or an individual) participates or potentially participates in an exchange for a good and/or a service. The exchange is not limited to a monetary transaction nor does it have to be a two way transaction with both parties contributing. It may be limited to, for example, a party reading a travel guide as written by one or more other parties.

TABLE 1
Dictionary of defined terms

| Term | Description |
|---|---|
| Alignment | Alignment is a preferred relative positioning of values in two or |
| | more values signatures when comparing values signatures. That |
| | is, when values signatures are aligned in a quantifiable manner |
| | when the each values signature's values are: |
| | i. quantifiably similar when aligned in a complementary manner; or |
| | ii. quantifiably dissimilar when aligned in a supplementary manner. |
| | The term alignment is a means to rank values signatures from |
| | those aligned in a complementary or supplementary manner |
| | relative to those values signatures not aligned. |
| | The relative alignment (strong or weak alignment) between a |
| | requestor and one or more providers is indicative of the |
| | strength and/or the productivity of the potential relationship. |
| Individual | The term “individual” is used to show, by example, a party's role |
| | in exchanges. Here an “individual” takes the role of a requestor |
| | or a provider of one or more goods or services. As a seeker of |
| | goods or service, the term individual may include, but not be |
| | limited to, customers, consumers, individual viewers, or any |
| | party that seeks goods and/or services in an active or passive |
| | manner, including transactions involving professional to |
| | professional (B2B) relationship and/or professional to |
| | consumers (B2C), so an individual may take the form of an |
| | organisation, where an organisation requests or provides a good |
| | or service. When we refer to the term “individual” we are |
| | referring to values obtained from a single entity which cannot |
| | be further separated into finer entities within this definition - |
| | thus a values signature is not an aggregation of values from |
| | different people. An individual's values and values signature can |
| | also be aggregated to form an organisation's values and values signature. |
| Fit | The fit of a provider meeting a requestor's need is revealed in |
| | terms of alignment of values signatures. This fit is determined, |
| | in one embodiment via a fitness function, which looks at the |
| | values signatures of a requestor and one or more providers and |
| | selects the most suitable providers by calculating how close the |
| | requirements for the requestor will be met by the provider in |
| | terms of: |
| | 1. meeting the specified request; and |
| | 2. the alignment of the values signature in either a |
| | supplementary or complementary manner. |
| | The terms alignment, correlation and fit are used to reveal the |
| | closeness of the relationship in terms of values between an |
| | individual and an organisation. Fit is a means to quantify how |
| | strong the potential relationship between a requestor and a |
| | selected provider is likely to be. The term “strong” used in this |
| | definition is used as an indicative indicator as the whether the |
| | potential relationship is to be more beneficial or productive |
| | depending on whether complementary or supplementary value |
| | signatures alignment are used. |
| Organisation | The term “organisation” is to include the values and values |
| | signatures from more than one person and may take the role of |
| | a requestor or a provider of one or more goods and/or services |
| | of all forms including professional service providers (for |
| | example, architects, doctors, lawyers, etc.), suppliers of another |
| | party's good and/or services, promoters, businesses (sole |
| | traders, partnerships, professionals etc.), groups, teams, |
| | regions, clubs, states, provinces, countries etc., essentially any |
| | group of 2 or more individuals. This provision of goods and/or |
| | services may be provided in an active (doctor, accountant, etc.) |
| | or passive manner (museum, streetscape, theatre, etc.) manner. |
| | In practice, an organisation may be a barista, architect, doctor, |
| | department store, where their values in the act of delivering |
| | goods and/or services are evaluated. An individual and an |
| | organisation may be used interchangeably as required to |
| | demarcate when values and values signatures come from a |
| | single person (an individual) or a plurality of individuals (an |
| | organisation). |
| Organisational | The term “organisational” is to include the operations of an |
| | “organisation” as defined as involving the values and values |
| | signatures comes from two or more individuals. |

The elements of the invention are now described under the following headings:

### DETAILED DESCRIPTION

The invention provides a new or alternate device, method and system to enable providers of goods and services to be assessed and aligned to the values and needs (as declared and/or interpreted) of a requestor's of the provider's goods and/or services (be they individuals or organisations).

Referring to FIG. 1, values are collected from an individual against a specified set of predefined values which are qualified and codified to form a values signature. Where two or more individuals are acting together as a requestor or provider, they are referred to as an organisation, which is used in the widest sense. The values contained in each individual's value signature are added together to form an organisation's value signature. Here there is a standardised form of reporting and comparing values signatures. The alignment of values signatures is enabled to be compared between individuals, organisations or a combination of individuals and organisations. The generation of reports enables the comparison and ranking of the most aligned requestors and providers via the alignment of their values signatures such that the alignment value signatures is enabled with one or more search engine algorithms performed on computer enabled devices.

Referring to FIG. 2, a requestor and a provider may either take the form of an individual or an organisation, where a request is made from a requestor and a provider, who offers and potentially delivers the requested goods and/or services. Therefore the roles of requestor and provider may take place between any one of the following combinations:
1. individuals and other individuals;
2. organisations and individuals;
3. organisations and individuals;
4. organisations and organisations.

The invention also provides a means for a user as a requestor (beit an individual or an organisation) to identify providers (including one or more organisations or individuals) whose values are aligned with the user's values, so as to access information that is useful or relevant to the user's needs or interests as shown in FIG. 3 (an individual and an organisation). Conversely, a poor fit and alignment between an individual and an organisation is shown in FIG. 4. Likewise, a good fit and alignment between two individuals is shown in FIG. 5, along with a poor fit in FIG. 6. Further, when two organisations are aligned, a good fit is shown in FIG. 7 whereas conversely when two organisations are not aligned, a bad fit is shown in FIG. 8.

The value assessment and alignment device is also enabled to meet a requestor's needs or interests, by implementing a value assessment process includes the steps of:
(a) defining a request from an individual or organisation, such that said individual or organisation becomes a requestor;
(b) receiving an offer an individual or organisation, such that said individual or organisation becomes a provider to meet said request, and
(c) selecting one or more aligned values signatures from a pool of provider values signatures to meet the request so defined,
wherein each said one or more values signature is a quantification of values from an individual, or collection of individuals forming an organisation, such that said alignment of values signatures is provided between an individual or organisation requesting one or more goods or services.

The value assessment and alignment device is enabled to review of one or more provider's fitness, which includes a review of:
1. the alignment of a provider's values signatures to the requestor's values signatures; and
2. the ability to meet the requestor's declared or inferred need.

A request may be declared or inferred due to the context of the request. An inferred request is enabled to take the form of perusing aligned values signatures alone without pursuing the delivery of a specific good or service from a provider. That is, an inferred need may take the form of taking a stroll along provider's operations who have aligned values signatures.

Visualisation of Correlated Values

This invention includes device, method and system for visualising an output of a user's values with one or more provider's (e.g. organisational) values as aligned by a value ranking method, and in particular for assisting access by a requestor (e.g. an individual) to one or more organisations by presenting the correlated fit (e.g. overlap) between, say, aligned user-organisation value rankings as displayed on the device. The device, method and system may be embodied in a plurality of computer programs stored on computer readable mediums or program storage devices and/or transmitted over a network.

Embodiments of the present disclosure provide one or more software products to generate and render visualisation from the output of a requestor's values as aligned to one or more providers (e.g. organisational) values. These values are aligned via values signatures derived from data submitted to the device. The correlated values between an individual and one or more organisations is enabled to be used as an adjunct to, for example, to existing keyword search engines, so as to enable a more appropriate result as aligned with the requestor's (e.g. searcher's) individual values.

Values Signature

A values signature contains the aggregated values from one party, beit an individual, organisation, team or other entity. The values signature contains information derived from data aggregated in the form of, for example, an alphanumeric code or other form of code which is computer readable and decipherable via a set of rules for which the underlying contributory values data is quantified and encoded for correlation with other value(s) and/or values signature(s).

Individuals and/or organisations have their values reflected within a “values signature”, which enables the collective or aggregated values of each party to be compared. This comparison maybe be performed by many techniques include the use of genetic algorithms to optimise a preferred fitness or outcome when comparing the values signature.

Values signatures are enabled to be generated from data collected or harvested from a party, such as an individual or an organisation, so that the values signature is able to be analysed to reflect one or more contributory values of an individual or an organisation.

An organisation is a group of individuals that come together to form an organisation, which may have a diverse or a collective set of values. Organisation values are also perceived by an individual. Individuals within an organisation are able to have their individual values aggregated with other organisational members to form an organisation's values signature. Consequently, a values signature is a depiction of either an individual's/organisation's/team's values depending on the individual relationship with others to offer or request a product.

In the case of an individual who joins an organisation, their values signature may be combined with values signatures of the other members of the organisation. Thus, a group of individuals may form an organisation with a collective organisational values signature.

The rules by which values are encoded into a values signature relies on the underlying values code being common between values signatures so as to be expressed in a simple table with all contributory value entities.

Depending on the “values signature” of the organisation that the individual contributes to, the expression of the individual “values signature” may differ in one organisation over another, since an individual's “values signature” may be masked or be promoted (using value weighting) by a different organisational “values signature” depending on where the individual resides and how the individual influences the organisation. These rules are contained in an algorithm that resides in value signature alignment algorithm (which may take the form of a genetic algorithm or an alternative multi-value alignment algorithm).

Here, a values signature is similar to the unique signature that is found in the works of, for example, notable artists and architects (or any work that is performed), where there are very specific “signatures” in the output generated. However, the difference to the signatures discussed in the arts is that this invention contains “values signature” that are a codified measurable signature in the form of information made from an array of specified contributory values as measured, harvested and/or declared from data containing an inference of each individual's or organisation's values in their output. Therefore, the use of a genetic algorithm and measure of fitness is a more quantifiable measurement means.

Value Selection

Values are reflected within the culture and behaviour of individuals and therefore may be derived from an individual's output, behaviour and/or cultural identification (popularly referred to a “tribe” by authors including Seth Godin).

A values signature is generated from the specified values uniquely identified with an individual or a collection of individuals, termed an organisation. Values are expressed by individuals and by organisations when they request or provide a good and/or service. The combination of specified values determines many aspects of a communication or transaction, such as each party's expectations, between individuals, organisations or combinations of the two. The combination of values, in the form of a values signature, is a means to enable the alignment of values between the parties, be they one of the following:
1. An individual with another individual;
2. An individual and an organisation;
3. An organisation and an individual;
4. One organisation with another organisation.

The advantage of the uniqueness of a values signature within an organisation is that an organisation's values signature is a collection of individual values signatures and cannot easily be duplicated. If another organisation tries to mimic or forge an originator's values signature, there are telltale signs to mark the difference between an originator and a copycat. A values signature, or collection of values signatures in an organisation is enabled to have a social overlay inserted, forming or representative of a social network. However, an organisation's values signature when fitting more aptly with their target requestors, maybe held as an optimised organisation. Other providers (e.g. organisations) may look at a successful values signature and lead their organisation towards targeting particular values within their organisational change management.

### A Preferred Embodiment

The preferred embodiment provides a new or alternative requestor-provider (e.g. individual-organisational) value alignment device, method and system for use in aligning and visualising values, and in particular, for optimising an requestor's (e.g. an individual's) values with one or more providers (e.g. organisations) with aligned or complementary values.

The value assessment and alignment device (VAAD) value assessment process includes the step of processing the requestor's and one or more providers' value signatures to determine the correlation of the values signatures with the requestor's declared need. This calculation is determined using a fitness function to calculate and rank which provider(s) meet said requestor's need and values, in terms of a values signature alignment, in a complementary or supplementary manner. The fitness function may take many forms as an algorithm including the adaptation of a genetic algorithm.

The choice of complementary or supplementary alignment is determined by the requestor, who in specifying whether complementary or supplementary values signatures are required, is stating whether they have a strength in these values or otherwise.

For example, a requestor who has poor self-fulfillment, lacks a sense of accomplishment and is insecure (three values within the values signature shown in FIG. 13) may specify a supplementary values signature as the choice of alignment with the provider's values signature.

The invention further provides a means to align values signatures between requestors and providers to deliver enhanced business relationships using an indicative outcome.

A preferred embodiment of the present invention will now be described by reference to the drawings. The following detailed description provides the skilled addressee with an understanding of the invention. It will be appreciated, however, that the invention is not limited to the applications described below.

The invention provides a Value Assessment and Alignment Device, method and system (VAAD) is a computer program product comprising programming instructions to assists individuals with a particular need to requesting from one or more providers, who have aligned values, to offer one or more suitable goods and/or service providers (e.g. individuals or organisations). The providers' values align with the requestor's values, via alignment of their values signatures.

By collapsing a provider (such as an organisation) into their contributory values in the form of values signature, a user of VAAD (taking the role as a requestor) is enabled to view one or more provider offerings as displayed by assessing their organisational values at an operational level. Here, the user potentially has the means to discern whether to choose and use one or more of an organisation's offerings based on the user's review of the organisation's values and alignment with one or more individual values.

A requestor may also use VAAD to view or distinguish providers by one or more of their component values. For example, a user may select VAAD to reveal one or more specific values within an organisation, so as to use aspects of an organisation where its value(s) fit within the boundaries of the user's values for specific tasks.

Where some offerings of an organisation do not fit with a user's values, the user is enabled to seek those offerings from other organisations. That is, where an organisation does not fit with a user's values, then that organisations products and/or services may be divided into their contributory parts, so that a another option/product/service can be sought from a more suitable organisation.

Referring to FIG. 9, a flowchart illustrates a method for value capture as performed by VAAD. Each entry into the flowchart is shown for exemplary purposes; however, there may be other steps included and/or the sequence of steps may be reordered.

Capturing Value Data

The first step is the extraction of values from one or more of the following:
1. an individual;
2. aggregated individuals;
3. an organisation; and/or
4. aggregated organisations.

Values are captured directly or indirectly via collection and/or extraction techniques using a variety of different methods known to those skilled within the art. Such value data capturing techniques include using, for example, gamification, which is a form of Dynamic Self-Adapting Data Collection means (DSADC—discussed further below).

There are alternate data collection means such as data harvesting, which to the person skilled in the art, may include a combination of techniques to be incorporated. Individuals are also enabled to self-declare their own values and act as informants to capture an organisation's values via the DSADC.

Gamification is the collection of data using a Dynamic Self-Adapting Data Collection means (DSADC) means, where other value assessment means are not suitable. For example, traditionally data collection used surveys, which are often tedious for a user to complete. The use of game play engages users to declare and test their values under dynamic and variable conditions using DSADC. Further, gamification enables standardisation of data collection and computer mediated collection for the values signature formation.

The second step is the determination of values: each value is collected separately or in unison with one or more other values from the data available (via DSADC extraction such as through data harvesting, gamification etc.) to determine the parameters of each value collected. This enables the quantification and qualification of each component value and the collective value signature.

In alternate embodiments of the invention, there are further value gathering and value verification steps required, as illustrated by the chain sampling step. The further gathering of values and/or value verification is not limited to chain sampling, but may also include analysis of behavioural files, literature read, lifestyle choices made et cetera.

The data underlying the values are enabled to be transformed into each value and collectively a values signature to provide information to form the basis of value & values signature comparisons. The values signature is shown as a third step in FIG. 9; however, this values signature is enabled to be constructed and/or reformed at any point that data is obtained that shifts a value or a values signature expression. Therefore, values and a values signature is enabled to be re-analysed, constructed or reformed when further data is obtained.

These first three steps giving rise to a values signature are enabled to be obtained from an individual or a collection of individuals representative of an organisation as shown in the right-hand column of FIG. 9. Once these values have been posted they are then enabled to be processed to correlate the values signature between an individual/organization/team and/or one or more organisations are shown in the central column of FIG. 9 (note: a team is used as a form of organisation) S. Differentiators between the values of an individual/organisation/team are enabled by, for example, to have information extraction techniques performed as parallel tasks.

In this alternate embodiment, individuals may also gather further information pertaining to one or more organisations through using techniques including gamification and/or chain sampling (step four).

Gamification provides a method to probe deeper into the user's values, including items such as the belief system and/or motivators. Gamification is also available to be used by VAAD when searching for a predetermined optimal fit, which may reflect a Q value as discussed in the background.

Likewise individuals are also enabled to state preferences as shown in step five. The combination of preferences and stated values, in the form of commentary about one or more organisations, enables individuals of like values to form collectives as shown in step six, which may be referred to as a tribe. The commentary, for example as collected through chain sampling, enables the difference between values measured (internal) and their perception (external). Specific weightings are enabled to be made via VAAD to ensure that actual and perceived values are appropriately balanced.

The VAAD device and method is also enabled to analyse products produced by an individual or organisation, such as publications produced so as to extract preferences of user, along with other criteria that determines how that user will fit with one or more tribes. That is, a user that enter data correlated with the values of one or more other users (be they providers in the form of individuals and/or organisations) are also enabled to become part of a specified tribe with like values via VAAD device and method.

Once the values data has been captured, a values signature is enabled to be generated from one or more individuals and/or organisations. An organisation's values signature is calculated by adding the values signatures of each individual within the same organisation to produce an organisation's values signature. Therefore, values signatures for individuals and for organisations are enabled to be generated. Likewise, perceived values are enabled to be also used to generate values signatures for individuals and/or for organisations. An organisation forms when individuals collectively deliver one or more goods or services. Values signatures are generated from individual's values data to form individual value signatures and organisation's values signatures. An organisation is used in the widest sense to include two or more individuals.

The alignment between different party's (individuals, organisations or combination thereof such as individual—individual, organisation—organisation or individual—organisation) values signatures is enabled to be calculated.

This calculation of values signatures alignment is determined by obtaining the correlation of component value data in respective values signatures between:
i. two or more individuals;
ii. two or more organisations; or
iii. one or more individuals and one or more organisations,

to identify one or more values signatures that are aligned in a complementary or supplementary manner.

A values signature may take many forms including an array where each value and its expression is numerically coded. This enables an alignment and consequently fit to be determined for values signatures between a plurality of parties by VAAD as shown in FIG. 9 via the central column.

Further analysis takes place through the incorporation, if required, of information obtained by chain sampling and preferences, so as to determine the tribe of an individual and/or an organisation. This information, when added to the alignment values signatures and any further preferences specified by the VAAD user, enables increased accuracy in the determination of the value alignment as shown in the central column of FIG. 9.

This information is enabled to be further analysed, if required, through applying an algorithm which weights the values signature information and/or preferences declared or extracted. This algorithm is enabled to order the results into prioritised set of applicable organisations are shown in the central column of FIG. 9. The VAAD user, when represented by the individual relative to one or more organisations prioritised, is located in a relative position compared to one or more organisations, so that sample size of extracted organisations can be adjusted.

The range of organisations extracted can also be adjusted to the level of correlation or fitness of values signatures. This adjustment can be quantified at one or more individual values or via the values signature as a whole. This adjustment is enabled to be set at a level plus or minus an acceptable quantifiable alignment level to locate suitable organisations with those parameters specified.

The prioritised list of suitable matches that fit specified values or the values signature as a whole may include preferences such as identical values signature organisations connected depending on optimised rout from the nearest to the furthest location within, for example, a 5 km radius.

Values signatures are enabled to be expressed in one or more selected visualisation formats, as preferentially selected, to reveal the alignment between the information obtained from, say the requesting individual and one or more provider organisations. These selected visualisations are shown in central column and include the form of one or more maps, paths, search results, rankings, et cetera.

These visual representation viewable by a VAAD user, e.g. through a computer display, tablet, smartphone or any other display connected to a processing means. The programming instructions of the VAAD device are performed by a processing means (e.g. a processor of the computer system). The VAAD device may communicate with a server or a computer network including the internet or the cloud, or a mobile communications network.

Referring to FIG. 10A, an individual and organisational values as performed by VAAD is shown such that the data obtained from various sources including DSADC, chain sampling, metadata, preferences, behavioural files, et cetera, forms are individual and/or organisational databases which are refreshed as new data becomes available. This databases form individual records, which are shown by FIG. 10B, are available to be correlated once a user of VAAD places in one or more pieces of information.

For example, a first step may, for example, take the form of a request for expertise from one or more providers with value signatures that fit the requester's value signature along with the required expertise. A search is enabled to be entered so that values of a requester, such as an individual, and/or one or more provides, such as organisations, can be correlated relating to search of the expertise required. The second step is to extract the values available to be selected as associated with provider's description of, say, expertise offered: that is, values only appropriate to the stated expertise description will be included in the subsequent correlation of values signature analysis. The third step will be to include one or more parameters such as the organisational size, service or goods available, distance from the individual and path(s) preferred.

Once data has been entered then the fourth step is to extract one or more organisations where the alignment of a preselected correlation or fitness to the requestor's (e.g. individual) values signature's or specific values. The information is then extracted at a fifth step, so as to prioritise organisations aligned to the specified required values at correlation/fitness level that is determined and selected as acceptable. This correlation level may be for a tight alignment, such as a correlation within the range of 0.6 to 0.8, or at greater range such as having a lower level such as 0.5 where the familiarity will be not so close so that a sense of exploration will be instilled (see Q values discussed previously).

Value Signature Determination

Individuals are often not able to directly specify their values in a question and answer manner such as in the form of likes and/or the dislikes. Therefore, is often important to monitor what an individual responds to via indirect (e.g. Gamification) or a more direct detection means (e.g. biosensing), rather than requesting participation in “conscious” decision making exercise(s) to glean values.

Conscious decision making exercise(s) such as surveys potentially filter out an individual's likes/dislikes and mask values due to the “conscious” processing that filters responses due to individuals often presenting an aspirational slant to their values or presenting learnt responses (e.g. men like cricket—I am a man therefore I like cricket; however, an honest answer maybe I find cricket incredibly boring).

In a further embodiment, data is enabled to be directly collected from a VAAD user through a variety of methods known to those skilled within the art including the use of a biosensing means.

Examples of such biodetection utilises micro-sweat detection via electrodermal response sensors (EDR sensors), which measure electrical conductivity fluctuations produce by changes in the micro-sweat rate in an individual's fingertips (most sensitive region). Other biosensor techniques include pupil size fluctuation along with associated eye movement. The EDR sensors pass microcurrents of electricity and measure changes in the current flow due to the presence/absence/change in micro-sweats. Individual micro-sweats change dynamically depending on whether an individual is stimulated or otherwise via screen-based stimulus.

For example, an individual is enabled to be evaluated as to their like/dislike of, for example, Formula One car racing. A sensor, placed on individual's fingertips whilst watching such racing, monitors the individual's response to stimulus or involvement in the on-screen activity. When the micro-sweat fluctuations coincide with “events” in Formula One, such as fast turns, over taking, collisions, etc., then it can be extrapolated that the individual is highly involved. In contrast, if no or low micro-sweat activity fluctuations take place or there is no dynamic change in the micro-sweat activity, then it may be extrapolated that the individual's level of involvement with such racing activity is low.

Such EDR sensors are enabled to be used to measure responses of an individual to different on-screen stimuli as pleasurable or otherwise. This individual micro-sweat activity response profile is enabled to be used to build or be added to a behavioural profile. Further, such micro-sweat activity is enabled to be used to demarcate in a finer grained manner as to an individual's preferable “likes” and “dislikes”.

A strong response in an individual's electrodermal response as detected by one or more EDR sensors may also be indicative of a strong dislike. Therefore, conscious confirmation of the like/dislike preferences may need to take place. In the absence of a conscious confirmation of “a liked” stimulus as detected by EDR sensors may also be confirmed by lack of accommodation to the screen-based stimulus. That is, the individual has ongoing involvement in the screen-based stimulus as shown by relatively poor accommodation to the stimulus. This electrodermal response sensor (EDR sensors) data is collected on an individual basis and is enabled to quantify a value along with associated preferences.

Such biosensors are enabled to detect arousal in both a fast and dynamic fashion so that changes in micro-sweats are enabled to be aligned so as to coincide with sensory stimuli. Screen based stimuli, such as visual and auditory activity, is enabled to be shown via a computer interface using VAAD and associated methodology.

EDR sensors with the VAAD and associated methodology are enabled to detect stimulus which is enabled to be confirmed as stimulating and pleasurable or conversely, causing displeasure to an individual. That is, the stronger the response does not coincide with increased pleasure. Here, calibration is enabled through the sequence of stimuli with conscious confirmation of pleasure/displeasure by the individual undergoing the calibration. Therefore interactive data collection is enabled to confirm a fit as to the VAAD user's values selections, tribes, aligned values paths (discussed further below) and search extracts delivered.

To take the example of Formula One racing further, the micro-sweat fluctuations as detected by the electrodermal response sensors are enabled to be shown to directly coincide with events such as corner manoeuvring. Control readings and collaboration must take place to determine how dynamic the micro-sweat rate of change is for an individual, since there may be a slight lag between one individual's responses when compared to another's response. These responses are then enabled to be confirmed by the individual.

Electrodermal response sensors are enabled to be set as a plug and play apparatus in conjunction with screen stimuli to sense an individual's likes/dislikes using VAAD and associated methodology. Gamification and other techniques are also enabled to be added to the matrix as a means of quantifying an individual's values.

Processing of resultant data is enabled to be used as both primary (direct) or a secondary (indirect) sources of data, which is enabled to be processed in conjunction with the screen data selected as stimuli and other data collected by chain sampling, self-declaration, dynamic self-adapting data testing and collection means, and other collection means. This data is then transformed into quantified values and values signatures.

Other means of detecting stimulus is preferable and engaging using the autonomic nervous system response characteristics includes pupil dilation fluctuation, respiration rate, pulse rate et cetera. The person skilled in the art would appreciate that in place and/or in conjunction with EDR sensors, these additional sensing criteria are enabled to be used as an adjunct or directly to determine the likes/dislikes of an individual.

Value Alignment Through Specific Value Selection

A values signature is enabled to be machine readable through various means including an alphanumeric code or expressed as an array. Each value has a relative strength or weakness when aligned between one or more individual/organisation/team, such that the degree of alignment is enabled to be extracted.

It is immaterial whether the values or values signature of an individual, team or the organisation scores highly, but it is important that the alignment is available as a relative positioning. Once one value is correlated then a further value is enabled to be correlated, such that the overall correlation via a plurality of values is available. This alignment can also take place through the correlation values signature which is the collection of separate value correlations combined.

Referring to FIG. 13, an exemplary visual representation of value alignment between and organisation and an individual is shown, which upon extracting the alignment of each component value, a values signature is enabled to be formed.

Additional Applications of VAAD

This prioritisation of providers, such as organisations offering goods and/or services, is able to be optimised with respect to one or more specific criteria such creating a path in the form of a journey through, for example, a particular historical period, historical event, movement et cetera.

The selection of the most suitable information is able to be accepted, rejected and/or reset by adding and/or subtracting organisations to tighten the results with regard to one or more particular criteria. A further iterative process is also enabled focus on the success or otherwise of the previous fitness of the providers presented. This involves feed forward and feedback loops to improve the results generated. A visualisation is then available to be generated such as a map taking the individual through a journey of selected organisations.

The visualisation is the result which, for example, reveals the alignment between the VAAD user, who is the individual aligned to one or more organisations selected.

A user inputs data into VAAD, which is a computer program that takes user input data, such as their desired goods and/or services along with their values signature, and matches its fitness via a correlation to one or more provider's goods/services and values signature as aligned—see step 110.

The input may be entered by typing into a keyboard, selecting an item (e.g. a business function) on the user interface by any suitable means (e.g. clicking, tapping) or inputting the data by any other suitable means. This may take the form of a user being presented with options for selection—for example, a visual representation—and selecting the desired option.

FIG. 11 contains an exemplary correlation of visual representation between individual and organisational values extracted from VAAD as performed and described with reference to FIG. 10B. Organisations are shown as most suitable (proximal—supplementary or complementary—to the user's values) in the area of intersection and less suitable (distal to the user's values) by having no intersection.

The broader the values correlation selected then the greater the overlap in the intersection between the requestor and the VAAD selected providers. Providers (e.g. organisations) when selected as closely correlated to the requestor (e.g. individual) by their values signatures is shown as a strong alignment and has a large intersection between the requestor and the provider or plurality of providers. Likewise, where the value alignment between one or more providers and the requestor has a poor overlap with little or no intersecting area, then this takes the form of a weak linked or unfit provider.

Requestors are also enabled to be selected into groups, which may be referred to as tribes; however the concept can also take place with teams. As a team changes then alignment can be improved so that the improved value mix is enabled to be selected to optimise the likelihood of a specific result.

A provider's fit is enabled to be ranked from a good fit to a poor fit in terms of values signatures alignment, when compared to a requestor's values signature. One or more providers' fitness as ranked, relative to a requestor's values signature, are subsequently enabled to be joined via a path to show the most suitable method to experience these providers' offering (such as places of business showrooms, galleries, etc.) in the form of branch lines.

Particular branch lines may be more comprehensive such that a broader range of organisations are included (organisations where the correlation of values signatures is broader), whilst a more direct branch line with a limited number of providers extracted due to a more limited correlation of values signatures may be depicted as a direct route. This may also be a more direct route due to limited time for provider review or some other parameter selected.

FIG. 12 shows, by way of example only, the alignment of values signatures in the form of a map reflecting correlations between outputs of a requestor's values signatures to one or more providers' values signatures as aligned values. This alignment of values is rendered onto a user interface on a screen of a computer (or on any form of computer enabled interface), as generated by VAAD.

The diagrammatic curation of output of a user's (requestor's) values (via their values signatures) to one or more provider's values (via their values signatures) as an aligned values path can include additional detail such as additional value or items of interest in the visual representation.

Method for Generating Values Alignments

Returning to FIG. 9, after receiving user input, VAAD searches a knowledge base of correlations between output of a requestor's values to one or more provider's values as approximately aligned values. The knowledgebase may contain correlations between outputs of a requestor's values to one or more provider's values as aligned values.

Once a user has input data relating to a plurality of user's values to one or more provider's values as aligned values, a user may then run a query to display the plurality of values as aligned values paths. This query will search the knowledge base for correlations between outputs of a user's values to one or more organisational values as aligned values and present the relevant correlations to an inference engine.

The inference engine takes the relevant paths to form a path optimisation by performing a transformation of the data into individual and organisational values alignments. That is, by generating a map of the output of a user's values to one or more organisational values as aligned values paths, VAAD also takes into account the chain sampled paths of other users so the boundaries of a output of a user's values is enabled to be extended to alignment other user's values branch line visualisations. This is an advantage because the correlations are enabled via VAAD to add new visualisations extending the scope of the user's input.

Such visualisations include additional detail specific to output of a user's values is aligned to only one path.

Values are represented individually and/or in collections of values, such as in cluster maps, spider diagrams, heat maps, radar/web graphs et cetera. The boundaries between an individual and an organisation's values are available to be mapped or graphed as an overlap, so that a correction factor is enabled to be allocated. For example a correction factor of, say, 0.5 is enabled to be set as a suitable value correlation operational threshold. Such thresholds are enabled to be set to adjust the correction factor to optimise the results returned and/or the fine tuning of the result so to suit an individual's preferences.

By analysing one or more organisations by their values, a user can utilise parts of the organisation that fits with the user's values as analysed and as aligned by VAAD; however, when values clash, the user can be made aware so as to avoid using that part of the organisation or the organisation at all.

That is, the VAAD when combining a requestor's values signature with one or more declared needs there is included a substep of subdividing a provider's goods and services such that said provider may more precisely meet a requestor's values signature and declared need(s) in conjunction with one or more other providers.

For example, when using the services of an architect, a design in the form of a plan may be adequately described and therefore suitable for purchase; however, implementation of the plan may be performed by another provider due to a greater fit of values with regard to service offerings and delivery that meet the individual's values as a customer.

Values Captured as Data

Values are collected in each value category from individuals and organisations in the form of data collections either:
1. directly (and verified via performing value testing); or
2. indirectly by extrapolating values from computerised records such as reflective analysis of viewing profiles.

A value analysis is performed, on the value data collected, so as to provide value boundaries.

Value Capture

To discern a value, there needs to be an immersive understanding of the operations of provider such as an organisation from a requestor's perspective. Therefore, users of a provider's goods and/or services act as informants and capture an organisation's values through the use of dynamic self-adapting data testing and collection means (discussed further below).

These data tests and collections capture information to reveal provider's values, which are reflective of the provider's (e.g. organisation's) delivered values, as opposed to their stated values. When captured data is in the form of qualitative values, a ranking of values is enabled to quantify such qualitative data.

A method for creation of requestor and provider value alignment and alignment involves capturing each party's values such as a requestor's values, in the form of a requestor's values profile, and fitting these values to one or more providers' values as aligned values and passing such data through an inference engine to derive the generation and rendering of a cluster value visualisation via VAAD (or an VAAD module within a computer enabled device) onto a computer enabled screen (or printed).

Vaad Includes:
(a) a rule engine, which is knowledge base of requestor and provider values signatures correlated to output as aligned values signatures according to alignment parameters selected;
(b) an inference engine (a computer program designed to produce reasoning based on rules) to derive an optimal path (shortest distance between one or more providers that most closely aligns to a requestor's values signature, sought goods and/or services and preferences). Those providers are ranked from most suitable to least suitable via their correlation of values signatures to the requestor's values signature;
(c) a user interface, to enable a user to adjust one or more of their preferences within VAAD so that a correlation of aligned values signatures will be more tightly aligned with a VAAD user's preferences.

For example, a output of a VAAD user's values to one or more provider's values signatures as VAAD aligned values may pass from most to least aligned organisations; however, when this output is extrapolated by joining other “chain sampled” paths (discussed below) then there is enabled an extension of the user's values signature aligning to a plurality of providers in the form of a branch line so as to more fully connect the most proximal to most distant organisation with aligned values along an accessible path as generated via VAAD.

Value Maps

In the preferred embodiment, the invention employs optimisation tools, so the VAAD user needs to frame accurate requestor criteria, such as keywords for the goods and/or services sought, to obtain access to relevant and values signature aligned providers. The VAAD aligns provider values signatures to reveal how similar (their fitness or correlation) to the requestor's values. Based on these values signature alignments, VAAD proposes providers relevant to the requestor.

Rule Engine

A rule engine can be used to assist the VAAD user to define one or more values or to further refine a value and consequently, the resultant values signature. A VAAD user may define a value through:
1. undertaking a derivative analysis using the gamification or other dynamic self-adapting data collection means; or
2. providing a literal answer.

Gamification or other dynamic self-adapting data collection means is used since many people cannot directly define their values without considerable reflection. Here, the rule engine connects VAAD user to their stated, revealed and/or selected values. This rule engine is enabled to exchange information with the dynamic self-adapting data collection means.

Consequently, the rule engine gleans the appropriate organisations without relying on a VAAD user understanding all the contextual relationships surrounding the values, but in different embodiments a probabilistic determination or alternatively a neural network approach may be used to determine values.

These methods include understanding output of a requestor's values signature as aligned to one or more providers' values signatures. Mapping the analysis of one or more providers that meet within the value alignment boundaries of the requestor, with the closest alignment being most aligned to the requestor and the least fitting provider(s) being most distal to the requestor, enables a linkage between providers to be made in the form of a path or route. This linkage, in forming a path, enables a path also to be viewed by others, which when taking of the form of a path that many others have followed, this becomes a branch line, which contains individuals with similar values.

Optimised Value Paths

VAAD assesses available organisational possibilities in terms of values signatures, so as to enable the requestor (e.g. user) to hop across the clusters of preferred values within values signatures, on a path marked:
1. from providers, such as one or more organisations, with the most correlated alignment. Here, the tightest fit (most proximal) may not always be the most suitable if supplementary values are required;
2. to the loosest fit (most distal), whilst avoiding non-optimal values.

In alternate embodiments, clusters of suitable providers are enabled to be linked via an optimised path to enable the degrees of separation to be much shorter than if guided by non-linked random provider possibilities.

VAAD additionally assists requestors, such as individuals, by presenting an interface which presents provider (e.g. organisational) “fit” in a visually curated manner, whose values signatures are within the boundaries of the values signatures of the requestor.

Curation of Value Rankings

VAAD generates the alignment of individual and organisational values signatures in the form of a visualisation by rendering it onto an interface of a computer enabled device, so that an image format is generated to reflect, for example, a curated analysis as a branch line map reflecting aligned values signatures between an requestor and provider(s) as mapped in an accessible form to those who read it.

For example, if the alignment to be selected is complementary (as opposed to supplementary alignments of values signatures), then a map of the providers that are most closely aligned to the requestor's values signatures are shown as most proximal to the requestor; whereas those providers that are interesting but have a poorer correlation to the requestor's values signatures are displayed at a more distal location to the requestor. Alternatively, individuals and organisations that show a positive fit may be shown in merely a list form.

These visualisation maps are presented as a curated map utilising an alignment method, which incorporates steps to rank alignment by specific criteria (complementary/supplementary/combination) in the form of correlated values signatures which form their fitness so as to map one or more values that are enabled to distinguish determinative values signatures alignment.

The value alignment is mapped and overlaid onto one or more providers. When value rankings have an optimised correlation co-efficient between a provider and a requestor, then these value rankings will be aligned proximally.

Reporting of Value Alignment Through a Curation of Offerings

This VAAD's value alignment selection leads to a selection of providers as suitable, using a curated output of the selection on an interface to VAAD.

Organisations and/or business are enabled to be searched with regard to their values signatures that are acceptable within the requestor's boundaries of values signature correlation tolerance(s) (depending on VAADs preference selected by the user).

Appropriate information from suitable sources are also presented using values signatures and keyword filters (restaurants, architects, technology devices, energy sources, banking organisations and other goods or services providers).

The value assessment and alignment device's value assessment process includes the step of rendering a report of said requestor's need(s) and one or more said provider's offering(s) as ranked by value alignment proximity in a variety of forms including one or more of the following:

i. a textual document;

ii. a visual representation, or

iii. a combination of (i) and (ii) above,

wherein said report is printable, downloadable or accessible by viewing on a display

Dynamic Self-Adapting Data Collection Means

When organisational values data collections are performed, the data collection techniques incorporating gamification such as Dynamic Self-Adapting Data Collection (DSADC) means to capture specific information such as sub-cultural values, which reflect the collective values in distinct subcultural groups. The DSADC means approach also utilises “chain sampling” as discussed below.

The DSADC means takes all components together to feed the database followed by the VAAD fitting the relationships based on the data collection means, together.

Gamification, using the DSADC approach avoid surveying and questionnaires since the “one survey fits all approach” often occludes insight into subcultures and importantly, early adopters and/or trendsetters. Surveys highlight the norms, whereas the DSADC approach is enabled to capture differentiating underlying value(s).

In further embodiment, gamification and other data collection means including DSADC are used to reflect the perspective of particular subgroups when chain sampling is used. This addresses criticism as to whether surveys are enabled to work as a tool to isolate individual values in the form of consumer preferences in cross-cultural situations. It further addresses the adaptation of surveys which remove questions for different communities rather than adapting questions to reveal pertinent information.

That is, if the question was not there, then the information cannot be captured, or conversely, if a data collection means shows insensitivity, then it will not be answered by specific informants who may be ostracized by such questions. The gamification data collection means approach enables specific organisational aspects to be revealed from specific viewpoints that are lost in known social ranking system (Reddit, Dig and the like) used on computing device.

The most “popular” organisations may occlude the discovery of very specific values and skillsets that are highly desired or of great interest to users of VAAD. Revealing values signature is the objective to make VAAD useful to users by providing a window into organisations from many different ethnographical, demographic and sociological perspectives.

Application of VAAD Specific Criteria

VAAD enables requestors such as users and providers, who both act as informants, to frame their values in a form that reflects their knowledge as to what influences the perception of values within or outside of the context of the collection technique used. Therefore, a dynamic series of questions in the form of DSADC is generated to be answered or rejected by the user/informant, which is adapted according to the previous acceptance and or rejection of questions by previous informants of, for example, the “chain sample” links. Therefore, the data collection is not performed by a survey where one data collection means fits all recipients. A core data set is used by VAAD to processing the data provided by DSADC with the associated weightings and preferences.

The value assessment and alignment device includes is enabled to perform a review of the alignment of values signatures between said requestor and one or more providers, wherein said review includes a substep of aligning said requestor's values signatures to identify values of greater impact on said requestor's declared or inferred need wherein enhanced weight given to selected predefined values greater impact on said requestor's need so that perceived alignment is enhanced. This enables specific weightings to be added to specific value within a values signature via VAAD to ensure that actual and perceived values are appropriately balanced (as discussed previously).

The providence of the informant's perception of a provider's value(s) is also captured, so that the values of, say, an organisation is enabled to be viewed from different perspectives—age, gender, culture, along with many other influences that change the value signature fitness between a requestor and a provider.

To gather the social context of the values collected there needs to be the gathering of both literal and derivative expressions of such values. This capturing of values therefore also requires the interpretation of the social meaning by the informants (people who are sensitive to the cultural expressions displayed by, say, an organisation) since many values in terms of likes and dislikes are not generally nor immediately obvious.

For example, the providers presented to a requestor, who is a VAAD user, may take the form of a connecting series of art, cultural and architectural installations, such as buildings and designed places, so that a path is enabled to be generated using VAAD for the user to follow.

Such a path would take the VAAD user across contemporary installations (present) or installations constructed at a previous time period (past) where the values that a person in, say, the 1960s, are enabled to be extrapolated so as to be aligned to a user's values today. Therefore, the architectural and artistic installation would not reflect contemporary installation, but installations of the 1960s.

Here, the VAAD user is enabled to be taken along a path to illustrate the drivers and expressions of values in a period prior to today (such as the 1960s). This creates a perspective available to the VAAD user, aligned with the values of a previous time period along with the cultural viewpoints of a person within that time period with similar values as the VAAD user.

Likewise, the values of, for example, an alter ego are enabled to show a different perspective on current environment. For example, a walk thought inner Sydney could be revealed via the values and perspective of a hippy, punk, razar gang member, jazz etc. A selection of pubs, parks, galleries and the like are available for values of today and/or a previous period.

Chain Sampling

In alternate embodiments, chain sampling is enabled to be used to capture and reflect variations in values signatures in collections of individuals, such as in team and/or organisations. The advantage of chain sampling is that it utilises informants to recruit other participants of a similar ilk (or leaning) to contribute their views on values with regard to an organisation/business or alternative provider offering, without diluting or normalising the perception of specific values. That is, subcultural viewpoints of values, which includes organisational and/or team values, are maintained through the generation of values signatures from the data provided by chain sampling.

Chain sampling may also be used by one or more VAAD users to build networks and/or to find subject matter that is hard to locate using traditional search methods. Further, research and knowledge are enabled to be located from extended associations (weak links, where there is a relatively low overlap between values signatures) as well as strong links, where there have been or are currently strong associations.

Value Verification

Value analysis is enabled to be performed through a variety of techniques including the use of an equivalence partitioning, where the use of value test cases enables derived values to be determined as consistent and quantifiable within and across particular ranges of values, whilst outlier values (outside these ranges) being reconciled or reallocated through additional testing.

Values test are carried out on selected or all values to uncover errors in the value results of one or more test cases, which is also valuable for detection in a change in values at, for example, the organisational level.

For example, an organisation may be taken over, or a new governing body such as a new board, executive management team, and/or hiring policy may be implemented, which in turn over time will result in a transition of organisational values and culture (as driven from values). Therefore, there is the need for value verification at, or over, particular time intervals to ensure the accuracy of the values signature.

This value data and analysis, as obtained from one or more individuals and organisations, is stored in a database, flatfile or other means of data storage. This data storage is then enabled to be searched by VAAD based upon defined parameters of the searcher.

Referring to FIG. 12, a range of four values is shown for an individual and for two organisations. These values vary greatly in FIG. 12 between two organisations when looking at the value of security, so that when choosing an organisation with respect to the value of security, organisation 2 is much more closely aligned to the values of the individual. Likewise, when looking at the value of openness to change, there is very little difference between organisation one and two so that there may be a second value parameter that becomes necessary to discern the most suitable organisation for the individual concerned. Individuals using VAAD initially are enabled to seek a tight correlation for a particular value, and then depending on the number of organisations extracted with the first data pass, or finally distinguish suitable organisations by selecting using one or more further values.

Multiple Perspectives

Subcultures lead trends and instigate social change. Therefore, viewing organisational values from within and/or across organisations from one or more subcultural viewpoints is enabled via VAAD. This provides a greater number of perspectives available to be viewed by a VAAD user.

A VAAD user is therefore enabled to ascertain the level of comfort and/or risk that they will be exposed to in searching and/or selecting one or more organisations with relatively close or, alternatively, a more distant value correlations.

Each addition of new chain sampled data provides new provenance data, which details “who” added “what” from which value's cultural/demographic or other viewpoint. Therefore, a user can utilise chain sampling on VAAD to follow one or more selected branch chains as so desired.

Value Layers

Values, once captured, are enabled to be divided, so that an overview of values may be presented in an aggregated form as a values signature, and then divided out into contributory values. The unwrapping of contributory values from collective values is enabled to reveal particular values that drive individual and organisational behaviours and their connection(s) in preference to other values.

For example, a value set may be considered as “ethical” in an overview qualitative form; however, these values may take a different course when considering the values relating to finances and/or timeliness. Therefore, values and their context are enabled to be delivered an accumulative manner and/or as a specific values depending on the requirements desired by the user.

Value Alignment

The alignment of, for example, an organisational values signature (including one or more organisational values) to a user's values signature incorporates the requirement of nominating contributory values that pertain to both an organisation and a user referencing that organisation.

That is, a similar collective value such as “ethical” may have had disparate sub-values leading to the same collective value. Therefore, the detection of contributory values needs to be isolated within the user's and organisational data to produce a meaningful alignment in values. This is also where the use of a “values signature” is critical in that a signature can contain all the contributory components for review and fit; whereas collective qualitative (e.g. “ethical”) or quantitative terms (e.g. ranking of 10) masks the contributory values.

Likewise, in the preferred embodiment, individual values are initially determined, then collated into a values signature. These individual values signatures are additive to enable the derivation of organisational values signatures as required, reflecting an organisation's culture.

A user of VAAD is enabled to select values from values signatures in one or more forms, including:
1. an overview qualitative form categorisation, such as ethical,
2. by subcategories, such as creative or transparent; and
3. by single values, such as timeliness.

Interpretation of Values

The user, via VAAD, is enabled to nominate the boundaries of the closeness of the above values and/or values signatures, by incorporating the use of a value alignment algorithm in an inference engine, consisting of a computer program designed to produce reasoning based on rules that assesses the contributory data, which in turn will derive a transaction output such as values signature.

The “boundaries” of the values alignment may be set, via VAAD's preference settings, to be within a correction factor of, say, 0.5 for the individual—organisation's value(s) or values signature (expressed as a value cluster) overlap. This would be nominating an optimization of the correlated results for a specific output.

For example, an innovative output theoretically sits in the range between 0.6 to 0.8 as discussed below. In VAAD this theoretical range is enabled to be selected so the alignment of values (or a plurality of values signatures) that are similar and complementary (for example, a correlation factor of 0.6 to 0.8) but not identical (an identical correlation equals 1.0). Likewise, supplementary value selection is also enabled.

This theoretical range is analogous with the use of Q values, as revealed in Brian Uzzi and Jarrett Spiro (2005) work to maximise innovative output, where the correlation factor was retrogradely analysed to be between 0.6 to 0.8. Thus, the correlation factor between an individual—organisation's value cluster overlap is enabled to be selected on VAAD for desired innovation or comfort, reflecting such retrograde theoretical findings.

The alignment of an organisation's values to a user's values signature enables:
1. a fit of both the provider's (e.g. organisation's) and the requestor's (e.g. user's) values signature enables a comparison of their correlation as a whole since individual values cannot be independently altered. Therefore, a values signature is not necessarily an equal alignment of values; and
2. an optimised output (so that the values signatures correlate closely providing a fit so the provider and the requester are aligned; however, they are also not so alike and so will encourage exchange and learning to optimise output).

VAAD enables the setting of preferences to be set by a user to permit a loose alignment, or conversely to nominate those organisations which would be more likely to result in a more creative or innovative output according to values nominated in Uzzi and Spiro's 2005 study. An output is enabled to be nominated in terms of values in an orthograde manner (a Q value is for retrograde analysis) between an individual and an organisation.

That is, the understanding of a particular individual's values, aligned but not necessarily exactly matching an organisation's values, is enabled to be used to optimise the delivery of goods and/or services by an organisation to that individual.

This value optimisation exploits two aspects similar to those isolated in the collaboration and creativity studies used in the “small world networks” by Uzzi and Spiro. That is, values influence behavior so that the clustering of the values between an organisation and an individual must have a loose correlation of overlap. Uzzi and Spiro's study nominated the optimised range to be equivalent to a correlation of 0.6 to 08 (not identical but also not too dissimilar) so that links within the clusters are self-enforcing to enable creative material to be exchanged) and to potentially increases the level of cohesion.

That is, in the delivery of a service between an organisation and an individual, there must be enough value cross over to share empathy, but also to challenge pre-existing presumptions and develop innovation.

VAAD must also take into account the values of one or more organisations to achieve a ranking in organisational fit to, say, the individual requestor so that it delivers an optimal output based on values signature overlap. This is to enable that optimisation of benefit for an individual, organisation and possibly also a social benefit, without restricting to only a limited number of options, since the fit of values may be optimised without impacting unnecessarily on, say, the cost of doing business.

That is, there are often other considerations that need to be taken into account such as physical proximity, cost, language, culture etc. These other considerations can also be entered as preferences into VAAD to optimise fit in relation to the resources available.

Preference Alignment

Values are examined and aligned so that a preference is enabled to be set on VAAD by a user so as to allow them to choose between a comfortable value set as opposed to the extremes of opposing values or cloned values, for which the later would take the form of being a complete reflection of values. This value alignment takes place through the alignment of values signatures for particular outcomes. That is, the alignment of values signatures is used to form an alignment for predictive outcome.

An optimised set of values are enabled to be selected on VAAD to enhance the exploration within the value boundaries so as to be interesting and/or stimulating to the user of VAAD. Those boundaries in values are personal selections such that “interesting” to one user may be horrifying to another user. For example, one user's values that are nominated as “interesting” as selected on a VAAD, which may be restrictive, whilst to another user, they may be expansive.

User Value Review

VAAD further assists individuals in “reading” value alignment paths from the closest to the loosest fit to guide in the understanding of what organisational values, and their fit, will help form a desired outcome. This further allows reflection as to why a presumed organisational “fit” do not always meet an actual fit. That is, an individual may need to review their values as to why alignment of values does not always occur.

For example, a user's values may be reviewed and altered:
1. if an VAAD user is exposed to additional values or value categories when following the chain sample branch intersecting with organisations proximal to the user values; then
2. the VAAD user is optionally led by VAAD to review their values as entered in VAAD.

This is to enable the user to further adapt their behaviours as the values change (to be aligned with, say, the chain sample branch that they are following). The behaviours change as the values are aligned to deliver an improved outcome.

This user value review is performed via the dynamic self-adapting data collection means to further isolate most suitable organisations in a more value focused manner. These further value review questions presented by the dynamic self-adapting data collection means are based on data collected from questions posed by previous VAAD users.

A VAAD user is therefore presented with options based on the collective knowledge and enquiries of earlier VAAD users, without needing to frame or even know what the next question should be. A VAAD user can continue along a number of iterations presented by the dynamic self-adapting data collection means to obtain a final result, leading to the change or focusing of the user's value.

Alternatively, a review of a user's values may take place:
1. if an alignment of the alignment in organisational offerings, as determined by the value alignment algorithm, is reported on the VAAD interface, it is enabled to provide feedback to the VAAD user as to which organisations are not suited to their values; then
2. the values behind the reported curated organisations are presented and are available to the user of VAAD for review.

This is to address the circumstance when the cognitive choice of a value set selected by a user may not coincide with the user's true values as represented by the curated organisations presented by VAAD.

Here, the user's review of the underlying values as presented via VAAD enables a reconsideration of the user's desired values. That is, the user when realising subjectively that the presented value set as chosen does not fit with the likes and dislike of the user, then a tweaking of value list is enabled. The value list is defined and validated from the individual's perspective. An individual's behaviours to one or more values as listed may change, so that the contributory value set in the values list is enabled to be amended or adapted to the data collection requirements.

The VAAD also enables review of one or more providers' fitness includes a review of a requestor's satisfaction with each service provider selected.

VAAD provides a feed-forward and feedback loop for the user to select and review value alignment outcomes. When there is a value clash on review, perhaps due to a cognitive dissidence between the user's selection and the organisations presented, then a further adjustment is enabled.

In summary, the value assessment and alignment device includes the step of performing a review of values signatures when additional values data becomes available to be added to each value within a value signatures so as to aid the alignment and consequently the fit of said provider's ability in meeting said requestor's values and need(s).

This review of one or more provider's alignment and fitness includes one or more of the following steps:

(a) quantifying values across said specified predefined values, compare to previous values obtained and, if changed, regenerate said values signature. This may be the requestor's or the provider's values forming regenerated values signatures;

(b) identifying one or more requestor's needs required;

(c) assessing any differences between requestor's needs required and one or more provider's offering(s);

(d) assessing existing aligned values signatures to identify one or more providers,

(e) wherein said review is performed at one or more of the following times:

i. before the step of performing a value assessment process;

ii. after the step of performing a value assessment process.

Access to Additional Detail

The value rankings as presented also incorporates commentary from a variety of inputs, including the informants, which are available to be reviewed and evaluated, for a variety of reasons including a means to provide feedback to the user as to why an organisation was selected to be a value alignment, when the fit does not appear to resonate with the user's values. The user is provided via VAAD with the means to access such commentary by drilling down into the organisation as displayed to reveal its values.

The invention includes a means for a VAAD user to “mine” values from within values signatures, whether they are overarching values or sub values such as timeliness. VAAD user is enabled also to choose the appropriate context that applies to the value chosen, such that timeliness may have the context of opening times (the value of access) which is different to the value of timeliness regarding delivery within particular boundaries.

Value Rankings Indicator

Values signatures are enabled to be reviewed as a value rankings indicator, which is a normalized value ranking across providers, such as organisations, so comparisons between organisations are enabled to be available for selection for the values signature as a whole or for particular selected values, without ambushing the user/requestor with an overload of information.

Users are also enabled to comment on the values signatures rankings indicator via VAAD as informants so as to communicate an essence of comfort, upset or any of the many arrays of emotions, which are captured and ranked as heightened positive or negative responses to the organisation's values as presented.

The providers selected and presented in a curated form via the interface of VAAD therefore have their ranking of values/values signatures readily accessible for review. These ranking presentations may take a number of forms including providing the closest value fit of providers in the form of organisations in one or more of the following:
1. a selected proximity to the location of the user requestor;
2. by the providence of expertise that the organisation is providing; or
3. the values that the organisation has drawn or broken away from (for example, law firms may have breakaway firms that have a more litigious approach and value set than their parent firm).

The value assessment and alignment device includes a review of assessment of one or more providers by:
(a) applying a flag to information to the relevant provider, wherein applying the flag determines whether or not the relevant provider possesses declared information regarding one or more of:
   i. location;
   ii. capacity;
   iii. specialisation;
   iv. experience;
   v. time;
   vi. cost;
(b) excluding one or more service providers who do not possess said declared information from offering goods or services to meet the requestor's need,
such that only said one or more service providers who possess said declared information are considered as a fit to meet said requestor's values signature and need.

The value assessment and alignment device aligns value signatures between a requestor and one or more providers of goods and services include one of the following further sub-steps:

(a) combining a requestor's values signature with their one or more needs with one or more provider's value signatures and declared information offerings such that a number of potentially suitable providers are included in said report(s);

(b) selecting one or more providers, wherein a provider is selected according to whether it is enabled to provide goods or services relevant to meet said requestor's identified value signature, need, and declared information as set within threshold parameters,

such that one or more appropriate providers are selected by specified declared information. That is, a requestor is enabled to specify whether a provider can provide a good or service within a cost range of $X to $Y within 5 km of the requestor in Z number of days.

Value rankings also draw on what is interesting about the organisation as opposed to just the organisation's purported offerings.

Qualification for Data Inclusion and Access

In an alternate embodiment, the participation of users involves the granting of a series of privileges to act as an informant to provide a contribution by invitation so that chain sampling is ensured.

VAAD also provides:
1. one or more filters to indicate particular demographic, ethnological or sociological perspectives—this enables perspectives to be followed by the user, which may take the user through a particular branch line in the local area for interest purposes as a form of perspective travel; and/or
2. other information that can be extracted such as an organisation's location, expertise, availability, etcetera.

When a VAAD user perceives input from a specific branch line to be valuable, a VAAD user can seek review of the values common to that branch line and how those values differ to the user's values. Consequently and reciprocally, if that branch provides a synergy, then VAAD may introduce the user to contribute as a chain sampled member of that branch line.

Curation of Knowledge Value Rankings

The invention provides means for a VAAD user to control or determine the direction of their values by selecting or rejecting particular branches of values signatures, where each values signature has a fixed value list. A preferred embodiment utilises a selection means to choose one or more branch line paths to enable the user to move along a branch's chosen organisations and to determine why those organisations are chosen.

A VAAD user does not need to frame a precise question to efficiently obtain useful information with regard to values and their alignment. Rather, the branch lines chosen can be followed or re-directed to a new branch line as selected. Filters provide the means to narrow the volume of organisations provided and contributing values so to refine the values signatures alignments offered. Filtering of non-values data is also enabled. For example, when a requestor's need is declared, which requires narrowing to obtain precise results, then filtering of this declared need is enabled.

One advantage of VAADs is that it enables the review of one or more outputs of a user's values to one or more organisational values as aligned values, as a visual output which enables predictive validity by understanding/recognising the output of a user's values to one or more organisational values as following branch lines of chain sampled values.

The invention thus provides a device, method and system that overcome at least one of the problems by providing correlations between a requestor's values to one or more providers' values as aligned via values signatures.

However, it will be appreciated that the invention is not restricted to this particular field and that it is not limited to particular embodiments or applications described herein.

Comprises/comprising when used in this specification is taken to specify the presence of stated features, integers, steps or performance but does not preclude the presence or addition of one or more other features, integers, steps, performance or groups thereof. Thus, unless the context clearly requires otherwise, throughout the description and the claims, the output of a user's values to one or more organisational values as aligned values activities ‘comprise’, ‘comprising’, and the like are to be construed in an inclusive sense as opposed to an exclusive or exhaustive sense; that is to say, in the sense of “including, but not limited to.

Although the invention has been described with reference to specific examples, it will be appreciated by those skilled in the art that the invention may be embodied in many different other forms.

1. A value assessment and alignment device for performing a method of generating value signatures, wherein the method includes a value assessment process,
wherein the value assessment process is performed by programming instructions embodied in a computer readable storage medium and includes the steps of:
(a) capturing value data, wherein the value data relates to specified predefined values of an individual;
(b) processing said value data to generate a values signature;
(c) generating an organisational values signature by adding a values signature from one individual to one or more values signatures of other individuals within the same organisation to produce a values signature of an organisation;
(d) calculating alignment of values signatures by determining the correlation of component value data in respective values signatures between:
i. two or more individuals;
ii. two or more organisations; or
iii. one or more individuals and one or more organisations,
to identify values signatures that are aligned in a complementary or supplementary manner;
wherein each said values signature is a quantification of values from an individual, or collection of individuals forming an organisation, such that said alignment of values signatures is provided between individuals, organisations or combination of an individual and one or more organisations.

2. The value assessment and alignment device of claim 1, wherein the value assessment process includes one or more of the further steps of:
(a) defining a request from an individual or organisation, such that said individual or organisation becomes a requestor;
(b) receiving an offer from an individual or organisation, such that said individual or organisation becomes a provider to meet said request, and
(c) selecting one or more aligned values signatures from a pool of provider values signatures to meet the request so defined,
wherein each said one or more values signature is a quantification of values from an individual, or collection of individuals forming an organisation, such that said alignment of values signatures is provided between an individual or organisation requesting one or more goods or services.

3. The value assessment and alignment device of claim 2, wherein the value assessment process includes the further step of:
processing said requestor's and one or more said providers' value signatures to determine said correlation of said values signatures with said requestor's declared need using a fitness function to calculate and rank which provider(s) meet said requestor's need and values signature alignment in a complementary or supplementary manner,
wherein the choice between choosing an alignment in terms of fit (beit similar—complementary—or opposite—supplementary) is determined by the requestor depending on their requirements.

4. The value assessment and alignment device as defined in claim 1, wherein the value assessment process includes the further step of:
(a) rendering a report of said requestor's need and one or more said provider's offering as ranked by value alignment proximity in a variety of forms including one or more of the following:
i. a textual document;
ii. a visual representation, or
iii. a combination of (i) and (ii) above,
wherein said report is printable, downloadable or accessible by viewing on a display.

5. The value assessment and alignment device of claim 3, wherein said fitness function is determined using an algorithm.

6. The value assessment and alignment device as defined in claim 1 and including a further step of performing a review of values signatures when additional values data becomes available to be added to each value within a value signatures so as to aid the alignment and consequently the fit of said provider's ability in meeting said requestor's values and need(s).

7. The value assessment and alignment device of claim 6 wherein the review of one or more provider's alignment and fitness includes one or more of the following steps:
(a) quantifying values across said specified predefined values, compare to previous values obtained and, if changed, regenerate said values signature;
(b) identifying one or more requestor's needs required;
(c) assessing any differences between requestor's needs required and one or more provider's offering(s);
(d) assessing existing aligned values signatures to identify one or more providers,
(e) wherein said review is performed at one or more of the following times:
i. before the step of performing a value assessment process;
ii. after the step of performing a value assessment process.

8. The value assessment and alignment device of claim 6 wherein the review of one or more providers fitness includes aligning a provider's values signatures to the requestor's values signatures and meeting the requestor's declared or inferred need.

9. The value assessment and alignment device of claim 6, wherein said review includes a substep of aligning said requestor's values signatures to identify values of greater impact on said requestor's declared or inferred need wherein enhanced weight given to selected predefined values greater impact on said requestor's need s that perceived alignment is enhanced.

10. The value assessment and alignment device of claim 6, wherein the review includes assessment of one or more providers by:
(a) applying a flag to information to the relevant provider,
wherein applying the flag determines whether or not the relevant provider possesses declared information regarding one or more of:
i. location;
ii. capacity;
iii. specialisation;
iv. experience;
v. time;
vi. cost;
(b) excluding one or more service providers who do not possess said declared information from offering goods or services to meet the requestor's need,
such that only said one or more service providers who possess said declared information are considered as a fit to meet said requestor's values signature and need.

11. The value assessment and alignment device according to claim 10 wherein the method of aligning value signatures between a requestor and one or more providers of goods and services includes one of the following further sub-steps:
(a) combining a requestor's values signature with their one or more needs with one or more provider's value signatures and declared information offerings such that a number of potentially suitable providers are included in said report(s);
(b) selecting one or more providers,
wherein a provider is selected according to whether it is enabled to provide goods or services relevant to meet said requestor's identified value signature, need, and declared information as set within threshold parameters,
such that one or more appropriate providers are selected by specified declared information.

12. The value assessment and alignment device of claim 11 wherein the step of combining a requestor's values signature with one or more declared needs includes a substep of subdividing a provider's goods and services such that said provider may more precisely meet a requestor's values signature and declared need(s) in conjunction with one or more other providers.

13. The value assessment and alignment device of claim 6, wherein the review includes a review of a requestor's satisfaction with each service provider selected.

14. A computer-enabled method of aligning value signatures between a requestor and one or more providers of goods or services including a value assessment and alignment process, wherein the value assessment process is performed by programming instructions embodied in a computer readable storage medium, wherein the value assessment process includes the steps of:
(a) capturing value data, wherein the value data relates to specified predefined values of an individual;
(b) processing said value data to generate a values signature;
(c) generating an organisational values signature by adding a values signature from one individual to one or more values signatures of other individuals within the same organisation to produce a values signature of an organisation;
(d) calculating alignment of values signatures by determining the correlation of component value data in respective values signatures between:
i. two or more individuals;
ii. two or more organisations; or
iii. one or more individuals and one or more organisations,
to identify values signatures that are aligned in a complementary or supplementary manner;
wherein each said values signature is a quantification of values from an individual, or collection of individuals forming an organisation, such that said alignment of values signatures is provided between individuals, organisations or combination of an individual and one or more organisations.

15. A computer-enabled method of aligning value signatures of claim 14, wherein the value assessment process includes one or more of the further steps of:
(a) defining a request from an individual or organisation, such that said individual or organisation becomes a requestor;
(b) receiving an offer from an individual or organisation, such that said individual or organisation becomes a provider to meet said request, and
(c) selecting one or more aligned values signatures from a pool of provider values signatures to meet the request so defined,
wherein each said one or more values signature is a quantification of values from an individual, or collection of individuals forming an organisation, such that said alignment of values signatures is provided between an individual or organisation requesting one or more goods or services.

16. The value assessment and alignment device of claim 15, wherein the value assessment process includes the further step of:
processing said requestor's and one or more said providers' value signatures to determine said correlation of said values signatures with said requestor's declared need using a fitness function to calculate and rank which provider(s) meet said requestor's need and values signature alignment in a complementary or supplementary manner,
wherein the choice between choosing an alignment in terms of fit (belt similar—complementary—or opposite—supplementary) is determined by the requestor depending on their requirements.

17. A computer-enabled method of aligning value signatures in claim 14, wherein the value assessment process includes the further step of:
(a) rendering a report of said requestor's need and one or more said provider's offering as ranked by value alignment proximity in a variety of forms including one or more of the following:
i. a textual document;
ii. a visual representation, or
iii. a combination of (i) and (ii) above,
wherein said report is printable, downloadable or accessible by viewing on a display.

18. A computer-enabled method of aligning value signatures of claim 16, wherein said fitness function is determined using an algorithm.

19. A computer-enabled method of aligning value signatures in claim 14, includes a further step of performing a review of values signatures when additional values data becomes available to be added to each value within a value signatures so as to aid the alignment and consequently the fit of said provider's ability in meeting said requestor's values and need(s).

20. A computer-enabled method of aligning value signatures of claim 19 wherein the review of one or more provider's alignment and fitness includes one or more of the following steps:
(a) quantifying values across said specified predefined values, compare to previous values obtained and, if changed, regenerate said values signature;
(b) identifying one or more requestor's needs required;
(c) assessing any differences between requestor's needs required and one or more provider's offering(s);
(d) assessing existing aligned values signatures to identify one or more providers,
(e) wherein said review is performed at one or more of the following times:
i. before the step of performing a value assessment process;
ii. after the step of performing a value assessment process.

21. A computer-enabled method of aligning value signatures of claim 19 wherein the review of one or more providers fitness includes aligning a provider's values signatures to the requestor's values signatures and meeting the requestor's declared or inferred need.

22. A computer-enabled method of aligning value signatures of claim 19, wherein said review includes a substep of aligning said requestor's values signatures to identify values of greater impact on said requestor's declared or inferred need wherein enhanced weight given to selected predefined values greater impact on said requestor's need s that perceived alignment is enhanced.

23. A computer-enabled method of aligning value signatures of claim 19, wherein the review includes assessment of one or more providers by:
(a) applying a flag to information to the relevant provider,
wherein applying the flag determines whether or not the relevant provider possesses declared information regarding one or more of:
i. location;
ii. capacity;
iii. specialisation;
iv. experience;
v. time;
vi. cost;
(b) excluding one or more service providers who do not possess said declared information from offering goods or services to meet the requestor's need,
such that only said one or more service providers who possess said declared information are considered as a fit to meet said requestor's values signature and need.

24. A computer-enabled method of aligning value signatures according to claim 23 wherein the method of aligning value signatures between a requestor and one or more providers of goods and services includes one of the following further sub-steps:
(c) combining a requestor's values signature with their one or more needs with one or more provider's value signatures and declared information offerings such that a number of potentially suitable providers are included in said report(s);
(d) selecting one or more providers,
wherein a provider is selected according to whether it is enabled to provide goods or services relevant to meet said requestor's identified value signature, need, and declared information as set within threshold parameters,
such that one or more appropriate providers are selected by specified declared information.

25. A computer-enabled method of aligning value signatures of claim 24 wherein the step of combining a requestor's values signature with one or more declared needs includes a substep of subdividing a provider's goods and services such that said provider may more precisely meet a requestor's values signature and declared need(s) in conjunction with one or more other providers.

26. A computer-enabled method of aligning value signatures of claim 19, wherein the review includes a review of a requestor's satisfaction with each service provider selected such that the alignment value signatures is enabled with one or more search engine algorithms.

27. A system for aligning value signatures between a requestor and one or more providers of goods or services including a value assessment and alignment process, wherein the value assessment process is performed by programming instructions embodied in a computer readable storage medium, wherein the value assessment process, includes:
(a) a value assessment and alignment device according to claim 1; and
a method of aligning value signatures according to claim 14.
